(19) United States
(12) Patent Application Publication
(10) Pub. No.: US 2016/0316773 A1
(43) Pub. Date: Nov. 3, 2016

(54) METHOD FOR IMMERSION CHILLING AND FREEZING TUNA BY CaCl2 WITH LOW SALT PENETRATION AMOUNT

(71) Applicant: Shanghai Ocean University, Shanghai (CN)

(72) Inventors: Jing Xie, Shanghai (CN); Huiwen Xu, Shanghai (CN); Jinfeng Wang, Shanghai (CN); Wenbo Huang, Shanghai (CN); Xingyin Wu, Shanghai (CN)

(73) Assignee: Shanghai Ocean University

(21) Appl. No.: 15/169,732

(22) Filed: Jun. 1, 2016

Related U.S. Application Data
(63) Continuation of application No. PCT/CN2015/097555, filed on Dec. 16, 2015.

(30) Foreign Application Priority Data
Apr. 29, 2015 (CN) 201510211323.X

(51) Int. Cl. A23B 4/09; A23B 4/027

(52) U.S. Cl. CPC A23B 4/09; A23B 4/027; A23L 1/325; A23V 2002/00

(57) ABSTRACT

A method for immersion chilling and freezing tuna by CaCl₂ with a low salt penetration amount, characterized by comprising following steps: carrying out a rapid block-cutting treatment on tuna meat under a sterile condition, and then immediately freezing the tuna blocks in CaCl₂ salt water with concentrations of 25-30% and temperatures of minus 25 ˜minus 40 DEG C. respectively; completely immersing the tuna blocks in the salt water, directly placing a control group in a refrigerator at minus 25 DEG., and when the central temperature of the tuna blocks achieves minus 18 DEG C., rapidly taking out the tuna blocks from the salt water, and measuring the salt penetration amount and the various quality indexes, wherein a chilling mode for the salt water is to place 400 g of the CaCl₂ salt water with the mass concentrations of 25.70%, 27.50%, 28.40% and 29.40% respectively in refrigerators at minus 25 DEG C., minus 30 DEG C., minus 35 DEG C. and minus 40 DEG C., and chilling to setting temperatures of refrigerator, wherein the temperature fluctuation ranges of the refrigerators are +/−1 DEG C. The method disclosed by the invention increases the freezing efficiency of the tuna meat, has a low salt penetration amount, effectively ensures the quality and the taste of the tuna meat, and has a wide application prospect.

### CROSS-REFERENCE TO RELATED APPLICATIONS

This application is a continuation of International Patent Application No. PCT/CN2015/097555 with an international filing date of Dec. 16, 2015, designating the United States, now pending, and further claims priority benefits to Chinese Patent Application No. 201510211323.X, filed Apr. 29, 2015. The contents of all of the aforementioned applications, including any intervening amendments thereto, are incorporated herein by reference.

### TECHNICAL FIELD

The invention relates to a method for freezing tuna, more particularly, to a method for immersion chilling and freezing tuna by CaCl₂ with a low salt penetration amount.

### BACKGROUND OF THE INVENTION

Tuna, delicate in meat and delicious in taste, is mainly used for omophagia. Tuna is generally captured in deep sea, and should be rapidly frozen within 36 hours after being captured, otherwise it is liable to undergo browning, so the freezing on fishing boat after capturing is very important. Traditional freezing methods are of low speed and poor quality, the quality of tuna meat is hard to reach omophagia standard. Immersion Chilling and Freezing (ICF) is a freezing mode with direct contact of cooling medium and frozen food, the cooling medium has the characteristics of non-toxicity, low temperature and high heat transfer, and immersion chilling and freezing by salt water is to select salt water as cooling medium, salt water is widely used in the freezing of aquatic products, fruits and vegetables due to its fast freezing speed and good quality. CaCl₂ salt water, in accordance with food hygiene requirements, is the common cooling medium in salt water freezing, and the eutectic point can reach minus 55 DEG C., minus 26 DEG C. air freezing is as a contrast by Carolina (Freezing of strawberries by immersion in CaCl₂ solutions, Food Chemistry, 2010, 123(2): 243-248), immersing the strawberries in CaCl₂ salt water under minus 20 DEG C. and freezing to minus 10 DEG C., results show the time of freezing to minus 10 DEG C. by CaCl₂ salt water is shortened 45 min than that of air freezing, and the juice loss rate of strawberries frozen by CaCl₂ salt water is significantly reduced after thawing. Salt water freezing can improve freezing speed and reduce cost, however, the mutual penetration of solute and food component is the key to restrict the development of Immersion Chilling and Freezing (ICF) technology. The salt penetration amount is affected by salt water concentration and time of immersion chilling and freezing, the concentration of CaCl₂ salt water is higher, the solute content is higher, however, the solution temperature is lower, the freezing speed is faster, and the time of immersion chilling and freezing in CaCl₂ water is shorter, so it is very important to study the affect of CaCl₂ salt water with different concentration and different temperature on salt penetration amount of tuna salt water freezing and quality. Requirements are higher for the quality and taste of tuna as an uncooked fish fillet. The study about the impact of salt water freezing on taste and quality of aquatic products is rarely reported, so it is of great significance for further optimizing salt water freezing technology to study how to reduce the salt penetration while ensuring the quality of aquatic products.

### SUMMARY OF THE INVENTION

In the process of freezing tuna on fishing boat using existing immersion chilling and freezing technology by CaCl₂ salt water, the penetration of CaCl₂ salt water will affect the taste of tuna meat and reduce the quality, so the invention provides a method for immersion chilling and freezing tuna by CaCl₂ with a low salt penetration amount to reduce the affect of taste of tuna meat and quality. And the method is of low cost and simple operation, which can be widely used in freezing tuna on fishing boat.

The invention is a new method for reducing the salt penetration amount in tuna meat and improving the quality, characterized in that the chilling of CaCl₂ salt water and the freezing of tuna blocks by CaCl₂ salt water, comprising following key steps:

(1) preparing 400 g of the CaCl₂ salt water with the mass concentrations of 25˜30% respectively;

(2) placing the prepared salt water in 600 mL of the beaker, placing respectively in refrigerators at minus 25 ˜minus 40 DEG C., and chilling to setting temperatures of refrigerator, wherein the temperature fluctuation ranges of the refrigerators are +/−1 DEG C.;

(3) carrying out a rapid block-cutting treatment on tuna meat under a sterile condition within super clean bench with a mass of 80˜100 g each block, both the chopping board and cutter for cutting the tuna meat are sterilized under high temperature;

(4) inserting the thermocouple probe of multipoint temperature collecting device in the geometric center of tuna blocks from the center of upper surface, collecting the central temperature variation of tuna blocks, completely immersing the tuna blocks in the salt water, directly placing a control group in a refrigerator at minus 25 DEG C., and when the central temperature of the tuna blocks achieves minus 18 ˜minus 25 DEG C., rapidly taking out the beaker and the tuna blocks, and measuring the salt penetration amount and the various quality indexes.

Chilling condition of CaCl₂ salt water: preparing 400 g of the CaCl₂ salt water with the mass concentrations of 25.70%, 27.50%, 28.40% and 29.40% respectively, and the corresponding freezing point is minus 31.2 DEG C, minus 38.6 DEG C., minus 43.6 DEG C. and minus 50.1 DEG C. respectively.

Chilling mode of CaCl₂ salt water: placing the prepared salt water in 600 mL of the beaker, placing respectively in refrigerators at minus 25 DEG C., minus 30 DEG C., minus 35 DEG C. and minus 40 DEG C. and chilling to setting temperatures of refrigerator, wherein the temperature fluctuation ranges of the refrigerators are +/−1 DEG C.

Pretreatment of tuna meat: carrying out a rapid 6 cm*5 cm*3 cm block-cutting treatment on tuna meat under a sterile condition within super clean bench with a mass of (90±5) g each block, both the chopping board and cutter for cutting the tuna meat are sterilized under high temperature.

Temperature measuring: inserting the thermocouple probe of multipoint temperature collecting device in the geometric center of tuna blocks from the center of 5 cm*3 cm surface, collecting the central temperature variation of tuna blocks, completely immersing the tuna blocks in the salt water, directly placing a control group in a refrigerator at minus 25 DEG C.

The salt penetration amount of tuna blocks and measuring condition of quality indexes: when the central temperature of the tuna blocks achieves minus 18 DEG C., rapidly taking out the beaker and the tuna blocks, and measuring the salt penetration amount and the various quality indexes.

The invention can reduce the impact on the taste of tuna meat in the process of immersion, and improve its quality with low cost and simple operation.

### BRIEF DESCRIPTION OF DRAWINGS

FIG. 1 is the temperature variation in the process of freezing tuna.

FIG. 2 is salt penetration amount of tuna blocks after different freezing modes.

FIG. 3 is loss rate variation of tuna juice after different freezing modes.

FIG. 4 is TVB-N value variation trend of tuna after different freezing modes.

FIG. 5 is TBA value variation of tuna after different freezing modes.

### DETAILED DESCRIPTION OF PREFERRED EMBODIMENTS

The invention is further explained with reference to embodiments for better understanding.

Embodiment 1: this embodiment is used for reducing the salt penetration amount of immersion chilling and freezing tuna by CaCl₂ salt water, and improving the quality of tuna meat after being frozen, comprising following steps:

(1) Preparing experiment materials: picking back meat of bigeye tuna, purchased from Zhejiang Fenghui Ocean Fishing Co., Ltd, which is direct vacuumized and freezing storaged under minus 55 DEG C. after being captured, killed and frozen, picking tuna meat with even individual, uniform meat color, and certain regular shape, and delivering back to laboratory for treatment within 5 min under frozen condition.

(2) Preparing low temperature CaCl₂ salt water: 1) preparing 400 g of the CaCl₂ salt water with the mass concentration of 25.70%; 2) placing in 600 mL of the beaker, placing in refrigerators at minus 25 DEG C. and chilling to setting temperatures of refrigerator, wherein the temperature fluctuation ranges of the refrigerators are +/−1 DEG C.

Pretreatment of tuna: carrying out a rapid 6 cm*5 cm*3 cm block-cutting treatment on fresh tuna meat under a sterile condition within super clean bench with a mass of (90±5) g each block.

(3) Experiment treatment: preparing 400 g of the CaCl₂ salt water with the mass concentrations of 25.70%, placing in 600 mL of the beaker, placing in refrigerators at minus 25 DEG C. and chilling to setting temperatures of refrigerator, wherein the temperature fluctuation ranges of the refrigerators are +/−1 DEG C., carrying out a rapid 6 cm*5 cm*3 cm block-cutting treatment on fresh tuna meat under a sterile condition within super clean bench, inserting the thermocouple probe of multipoint temperature collecting device in the geometric center of tuna blocks from the center of 5 cm*3 cm surface, collecting the central temperature variation of tuna blocks, completely immersing the tuna blocks in the salt water, directly placing a control group in a refrigerator at minus 25 DEG C., and when the central temperature of the tuna blocks achieves minus 18 DEG C., rapidly taking out the beaker and the tuna blocks, the salt penetration amount of frozen tuna blocks of this embodiment is 4.07%, loss rate of juice is 1.2%, Total Volatile Basic Nitrogen (TVB-N) value is 10.55 mg/100 g, and Thiobarbituric Acid (TBA) value is 0.675 mg/100 g.

Embodiment 2: this embodiment is used for reducing the salt penetration amount of immersion chilling and freezing tuna by CaCl₂ salt water, and improving the quality of tuna meat after being frozen, comprising following steps:

(1) Preparing experiment materials: picking back meat of bigeye tuna, purchased from Zhejiang Fenghui Ocean Fishing Co., Ltd, which is direct vacuumized and freezing storaged under minus 55 DEG C. after being captured, killed and frozen, picking tuna meat with even individual, uniform meat color, and certain regular shape, and delivering back to laboratory for treatment within 5 min under frozen condition.

(2) Preparing low temperature CaCl₂ salt water: 1) preparing 400 g of the CaCl₂ salt water with the mass concentration of 27.50%. 2) placing in 600 mL of the beaker, placing in refrigerators at minus 30 DEG C. and chilling to setting temperatures of refrigerator, wherein the temperature fluctuation ranges of the refrigerators are +/−1 DEG C.

Pretreatment of tuna: carrying out a rapid 6 cm*5 cm*3 cm block-cutting treatment on fresh tuna meat under a sterile condition within super clean bench with a mass of (90±5) g each block.

(3) Experiment treatment: preparing 400 g of the CaCl₂ salt water with the mass concentrations of 27.50%, placing in 600 mL of the beaker, placing in refrigerators at minus 30 DEG C. and chilling to setting temperatures of refrigerator, wherein the temperature fluctuation ranges of the refrigerators are +/−1 DEG C., carrying out a rapid 6 cm*5 cm*3 cm block-cutting treatment on fresh tuna meat under a sterile condition within super clean bench, inserting the thermocouple probe of multipoint temperature collecting device in the geometric center of tuna blocks from the center of 5 cm*3 cm surface, collecting the central temperature variation of tuna blocks, completely immersing the tuna blocks in the salt water, directly placing a control group in a refrigerator at minus 25 DEG C., and when the central temperature of the tuna blocks achieves minus 18 DEG C., rapidly taking out the beaker and the tuna blocks, the salt penetration amount of frozen tuna blocks of this embodiment is 4.01%, loss rate of juice is 1.1%, Total Volatile Basic Nitrogen (TVB-N) value is 10.5 mg/100 g, and Thiobarbituric Acid (TBA) value is 0.65 mg/100 g.

Embodiment 3: this embodiment is used for reducing the salt penetration amount of immersion chilling and freezing tuna by CaCl₂ salt water, and improving the quality of tuna meat after being frozen, comprising following steps:

(1) Preparing experiment materials; picking back meat of bigeye tuna, purchased from Zhejiang Fenghui Ocean Fishing Co., Ltd, which is direct vacuumized and freezing storaged under minus 55 DEG C. after being captured, killed and frozen, picking tuna meat with even individual, uniform meat color, and certain regular shape, and delivering back to laboratory for treatment within 5 min under frozen condition.

(2) Preparing low temperature CaCl₂ salt water: 1) preparing 400 g of the CaCl₂ salt water with the mass concentration of 28.40%. 2) placing in 600 mL of the beaker, placing in refrigerators at minus 35 DEG C. and chilling to setting temperatures of refrigerator, wherein the temperature fluctuation ranges of the refrigerators are +/−1 DEG C.

Pretreatment of tuna: carrying out a rapid 6 cm*5 cm*3 cm block-cutting treatment on fresh tuna meat under a sterile condition within super clean bench with a mass of (90±5) g each block.

(3) Experiment treatment: preparing 400 g of the CaCl₂ salt water with the mass concentrations of 28.40%, placing in 600 mL of the beaker, placing in refrigerators at minus 35 DEG C. and chilling to setting temperatures of refrigerator, wherein the temperature fluctuation ranges of the refrigerators are +/−1 DEG C., carrying out a rapid 6 cm*5 cm*3 cm block-cutting treatment on fresh tuna meat under a sterile condition within super clean bench, inserting the thermocouple probe of multipoint temperature collecting device in the geometric center of tuna blocks from the center of 5 cm*3 cm surface, collecting the central temperature variation of tuna blocks, completely immersing the tuna blocks in the salt water, directly placing a control group in a refrigerator at minus 25 DEG C., and when the central temperature of the tuna blocks achieves minus 18 DEG C., rapidly taking out the beaker and the tuna blocks, the salt penetration amount of frozen tuna blocks of this embodiment is 3.95%, loss rate of juice is 0.9%, Total Volatile Basic Nitrogen (TVB-N) value is 10.42 mg/100 g, and Thiobarbituric Acid (TBA) value is 0.625 mg/100 g.

Embodiment 4: this embodiment is used for reducing the salt penetration amount of immersion chilling and freezing tuna by CaCl₂ salt water, and improving the quality of tuna meat after being frozen, comprising following steps:

(1) Preparing experiment materials: picking back meat of bigeye tuna, purchased from Zhejiang Fenghui Ocean Fishing Co., Ltd, which is direct vacuumized and freezing storaged under minus 55 DEG C. after being captured, killed and frozen, picking tuna meat with even individual, uniform meat color, and certain regular shape, and delivering back to laboratory for treatment within 5 min under frozen condition.

(2) Preparing low temperature CaCl₂ salt water: 1) preparing 400 g of the CaCl₂ salt water with the mass concentration of 29.40%. 2) placing in 600 mL of the beaker, placing in refrigerators at minus 40 DEG C. and chilling to setting temperatures of refrigerator, wherein the temperature fluctuation ranges of the refrigerators are +/−1 DEG C.

Pretreatment of tuna: carrying out a rapid 6 cm*5 cm*3 cm block-cutting treatment on fresh tuna meat under a sterile condition within super clean bench with a mass of (90±5) g each block.

(3) Experiment treatment: preparing 400 g of the CaCl₂ salt water with the mass concentrations of 29.4%, placing in 600 mL of the beaker, placing in refrigerators at minus 40 DEG C. and chilling to setting temperatures of refrigerator, wherein the temperature fluctuation ranges of the refrigerators are +/−1 DEG C., carrying out a rapid 6 cm*5 cm*3 cm block-cutting treatment on fresh tuna meat under a sterile condition within super clean bench, inserting the thermocouple probe of multipoint temperature collecting device in the geometric center of tuna blocks from the center of 5 cm*3 cm surface, collecting the central temperature variation of tuna blocks, completely immersing the tuna blocks in the salt water, directly placing a control group in a refrigerator at minus 25 DEG C. and when the central temperature of the tuna blocks achieves minus 18 DEG C., rapidly taking out the beaker and the tuna blocks, the salt penetration amount of frozen tuna blocks of this embodiment is 3.81%, loss rate of juice is 0.75%, Total Volatile Basic Nitrogen (TVB-N) value is 10.35 mg/100 g, and Thiobarbituric Acid (TBA) value is 0.575 mg/100 g.

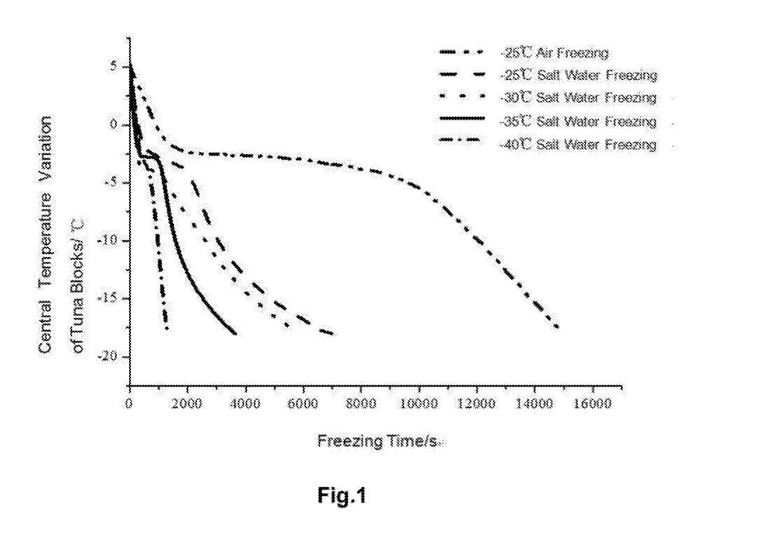

Experiment results show, as FIG. 1 shown, when frozen at minus 25 DEG C. salt water and the central temperature of the tuna blocks achieves minus 18 DEG C., time needed is 6991 seconds, when frozen at minus 30 DEG C. salt water and the central temperature of the tuna blocks achieves minus 18 DEG C., time needed is 6000 seconds, when frozen at minus 35 DEG C. salt water and the central temperature of the tuna blocks achieves minus 18 DEG C., time needed is 4000 seconds, when frozen at minus 40 DEG C. salt water and the central temperature of the tuna blocks achieves minus 18 DEG C., time needed is only 1311 seconds, and as the contrast group, and when frozen at minus 25 DEG C. air and the central temperature of the tuna blocks achieves minus 18 DEG C., time needed is 15000 seconds. So the conclusion is that the freezing effect of CaCl₂ salt water is better, and the freezing temperature of salt water is lower, the freezing speed of tuna blocks is faster.

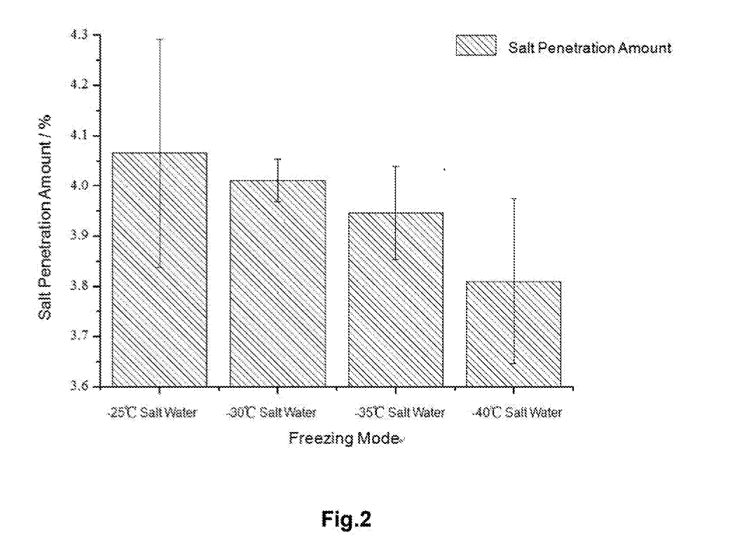

As FIG. 2 shown, when frozen at minus 25 DEG C. salt water, the salt penetration amount of tuna blocks is 4.07%, when frozen at minus 30 DEG C. salt water, the salt penetration amount of tuna blocks is 4.01%, when frozen at minus 35 DEG C. salt water, the salt penetration amount of tuna blocks is 3.95%, and when frozen at minus 40 DEG C. salt water, the salt penetration amount of tuna blocks is only 3.81%. So the conclusion is that the freezing temperature of salt water is lower, the salt penetration amount is lower, and the freezing speed of tuna blocks is faster, the taste of tuna meat is better.

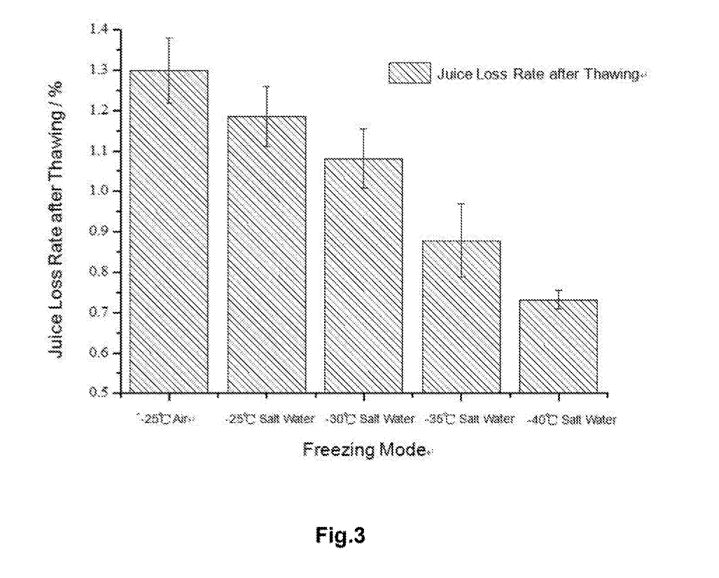

As FIG. 3 shown, when frozen at minus 25 DEG C. salt water, the juice loss rate of tuna blocks is 12%, when frozen at minus 30 DEG C. salt water, the juice loss rate of tuna blocks is 1.1%, when frozen at minus 35 DEG C. salt water, the juice loss rate of tuna blocks is 0.9%, and when frozen at minus 40 DEG C. salt water, the juice loss rate of tuna blocks is only 0.75%. So the conclusion is that the freezing temperature of salt water is lower, the juice loss rate of tuna blocks after thawing is lower.

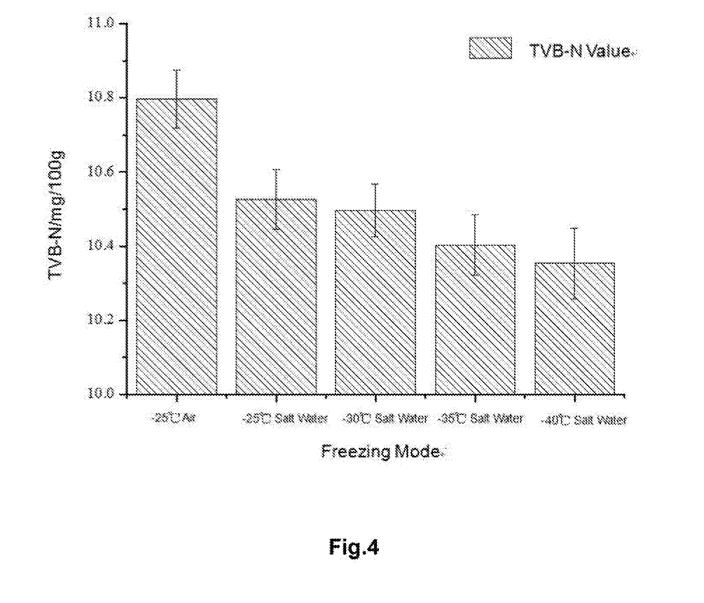

As FIG. 4 shown, when frozen at minus 25 DEG C. salt water, the TVB-N value of tuna blocks is 10.55 mg/100 g, when frozen at minus 30 DEG C. salt water, the TVB-N value of tuna blocks is 10.5 mg/100 g, when frozen at minus 35 DEG C. salt water, the TVB-N value of tuna blocks is 10.42 mg/100 g, and when frozen at minus 40 DEG C. salt water, the TVB-N value of tuna blocks is 10.35 mg/100 g. So the conclusion is that the freezing temperature of salt water is lower, the TVB-N value is lower and the taste of tuna meat is better.

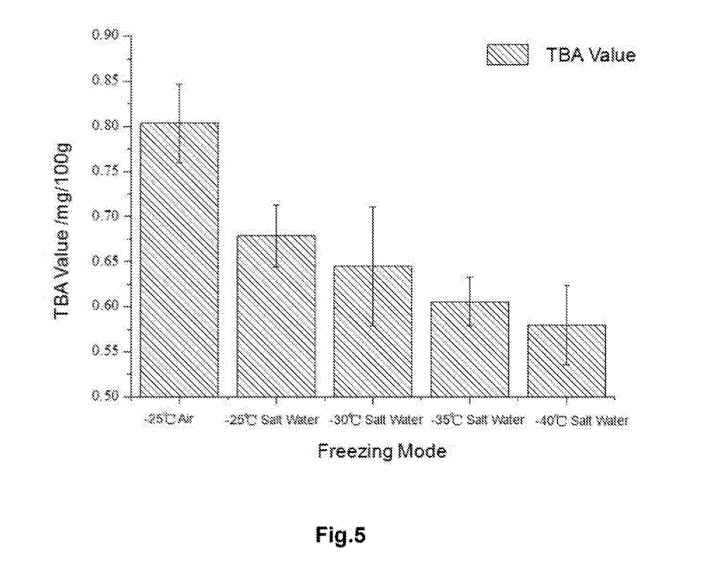

As FIG. 5 shown, when frozen at minus 25 DEG C. salt water, the TBA value of tuna blocks is 0.675 mg/100 g, when frozen at minus 30 DEG C. salt water, the TBA value of tuna blocks is 0.65 mg/100 g, when frozen at minus 35 DEG C. salt water, the TBA value of tuna blocks is 0.625 mg/100 g, and when frozen at minus 40 DEG C. salt water, the TBA value of tuna blocks is 0.575 mg/100 g. So the conclusion is that the freezing temperature of salt water is lower, the TBA value is lower and the taste of tuna meat is better.

Compared with ordinary air freezing, CaCl₂ salt water freezing can significantly improve freezing speed, and maintain fresh quality of tuna meat; the temperature of CaCl₂ salt water is lower, the quality of aquatic product is higher under same freezing temperature; when the same freezing end is achieved, the concentration of CaCl₂ salt water is higher, the corresponding salt water temperature is lower, the freezing speed of tuna meat is faster, and the salt penetration amount is lower than CaCl₂ salt water with low concentration, which has little impact on taste of tuna meat. The lowest salt penetration amount of CaCl₂ salt water is 3.81% under minus 40 DEG C., in practical use, the captured tuna is directly frozen after removing head and visera and cleaning, in this way, the penetration of salt will be reduced due to the tuna skin, so it is suggested to freeze large block of tuna (especially the whole tuna) by salt water.

We claim:

1. A method for immersion chilling and freezing tuna by CaCl₂ with a low salt penetration amount, characterized in t hat the chilling of CaCl₂ salt water and the freezing of tuna blocks by CaCl₂ salt water, comprising following steps:
(1) picking tuna meat with even individual, uniform meat color, and certain regular shape, and delivering back to laboratory for treatment within 5 min under frozen condition;
(2) preparing 400 g of the CaCl₂ salt water with the mass concentrations of 25.70%, 27.50%, 28.40% and 29.40% res pectively, and the corresponding freezing point is minus 31.2 DEG C., minus 38.6 DEG C., minus 43.6 DEG C. and minus 50.1 DEG C. respectively;
(3) placing the prepared salt water in 800 mL of the beaker, placing respectively in refrigerators at minus 25 ˜minus 40 DEG C., and chilling to setting temperatures of refrigerator, wherein the temperature fluctuation ranges of the refrigerators are +/−1 DEG C.;
(4) carrying out a rapid block-cutting treatment on fresh tuna meat under a sterile condition within super clean bench with a mass of 80˜100 g each block, both the chopping board and cutter for cutting the tuna meat are sterilized under high temperature;
(5) inserting the thermocouple probe of multipoint temperature collecting device in the geometric center of tuna blocks from the center of upper surface, collecting the central temperature variation of tuna blocks, completely immersing the tuna blocks in the salt water, directly placing a control group in a refrigerator at minus 25 DEG C., and when the central temperature of the tuna blocks achieves minus 18 ˜minus 25 DEG C., rapidly taking out the beaker and the tuna blocks, and measuring the salt penetration amount and the various quality indexes.

2. The method for immersion chilling and freezing tuna by CaCl₂ with a low salt penetration amount according to claim 1, characterized in that placing the prepared salt water in 600 mL of the beaker, placing respectively in refrigerators at minus 25 DEG C., minus 30 DEG C., minus 35 DEG C. and minus 40 DEG C., and chilling to setting temperatures of refrigerator, wherein the temperature fluctuation ranges of the refrigerators are +/−1 DEG C.

3. The method for immersion chilling and freezing tuna by CaCl₂ with a low salt penetration amount according to claim 1, characterized in that carrying out a rapid 6 cm*5 cm*3 cm block-cutting treatment on fresh tuna meat under a sterile condition within super clean bench with a mass of (90±5) g each block, both the chopping board and cutter for cutting the tuna meat are sterilized under high temperature.

4. The method for immersion chilling and freezing tuna by CaCl₂ with a low salt penetration amount according to claim 1, characterized in that inserting the thermocouple probe of multipoint temperature collecting device in the geometric center of tuna blocks from the center of 5 cm*3 cm surface, collecting the central temperature variation of tuna blocks, completely immersing the tuna blocks in the salt water, directly placing a control group in a refrigerator at minus 25 DEG C.

5. The method for immersion chilling and freezing tuna by CaCl₂ with a low salt penetration amount according to claim 1, characterized in that when the central temperature of the tuna blocks achieves minus 18 DEG C., rapidly taking out the beaker and the tuna blocks, and measuring the salt penetration amount and the various quality indexes.

6. The method for immersion chilling and freezing tuna by CaCl₂ with a low salt penetration amount according to claim 1, characterized in that when the temperature of CaCl₂salt water is minus 40 DEG C., the salt penetration amount is 3.81%.
